(19) United States
(12) Patent Application Publication
(10) Pub. No.: US 2013/0297912 A1
(43) Pub. Date: Nov. 7, 2013

(54) APPARATUS AND METHOD FOR DYNAMIC ALLOCATION OF EXECUTION QUEUES

(71) Applicants: Thang M. Tran, Austin, TX (US); Sourav Roy, Kolkata (IN)

(72) Inventors: Thang M. Tran, Austin, TX (US); Sourav Roy, Kolkata (IN)

(73) Assignee: Freescale Semiconductor, Inc., Austin, TX (US)

(21) Appl. No.: 13/462,993

(22) Filed: May 3, 2012

(51) Int. Cl. G06F 9/30

(52) U.S. Cl. 712/208; 712/E09.028

(57) ABSTRACT

A processor reduces the likelihood of stalls at an instruction pipeline by dynamically extending the size of a full execution queue. To extend the full execution queue, the processor temporarily repurposes another execution queue to store instructions on behalf of the full execution queue. The execution queue to be repurposed can be selected based on a number of factors, including the type of instructions it is generally designated to store, whether it is empty of other instruction types, and the rate of cache hits at the processor. By selecting the repurposed queue based on dynamic factors such as the cache hit rate, the likelihood of stalls at the dispatch stage is reduced for different types of program flows, improving overall efficiency of the processor.

### FIELD OF THE DISCLOSURE

The present disclosure relates generally to processors and more particularly relates to execution queues of a processor.

### BACKGROUND

Some processors employ an instruction pipeline having execution queues that store instructions awaiting provision to an execution engine. In addition, after provision of an instruction to its execution engine, the instruction typically remains stored in its execution queue until it has reached a designated stage of execution. Accordingly, an instruction that is slow to execute can remain in the queue for a long period of time, delaying the execution of other instructions in the queue. When the delay results in an execution queue becoming filled, other instructions can become stalled at earlier stages of the instruction pipeline, reducing processor efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a processor in accordance with one embodiment of the present disclosure.

FIG. 2 is a block diagram illustrating portions of the processor of FIG. 1 in accordance with one embodiment of the present disclosure.

FIG. 3 is a block diagram of illustrating additional details of the processor of FIG. 1 in accordance with one embodiment of the present disclosure.

FIG. 4 is a block diagram illustrating an example of the scoreboard and other portions of the processor of FIG. 3 in accordance with one embodiment of the present disclosure.

FIGS. 5 and 6 illustrate flow diagrams of a method of assigning an instruction to an execution queue of the processor of FIG. 1 in accordance with one embodiment of the present disclosure.

### DETAILED DESCRIPTION

A processor reduces the likelihood of stalls at an instruction pipeline by dynamically extending the size of a full execution queue. To extend the full execution queue, the processor temporarily repurposes another execution queue to store instructions on behalf of the full execution queue. The execution queue to be repurposed can be selected based on a number of factors, including the type of instructions it is generally designated to store, whether it is empty of other instruction types, and the rate of cache hits at the processor. By selecting the repurposed queue based on dynamic factors such as the cache hit rate, the likelihood of stalls at the dispatch stage is reduced for different types of program flows, improving overall efficiency of the processor.

To illustrate, the processor employs multiple execution queues, with each execution queue generally assigned to store a particular type of instruction. Thus, for example, the processor can include multiple load/store queues to store load and store instructions, multiple simple queues to store simple instructions (instructions configured to take a single clock cycle to execute), and multiple complex queues to store complex instructions (instructions configured to take multiple clock cycles to execute). The dispatch stage assigns an instruction to an execution queue based on the type of instruction and on whether the instruction is dependent on another instruction. As used herein, Instruction A is dependent on Instruction B if Instruction A includes a source operand that is a destination operand of Instruction B and Instruction B has not yet completed execution. A dependent instruction is stored at the same execution queue as the instruction from which it depends, ensuring that dependent instructions are executed in order.

The simple execution units are duplicated in the complex execution unit and load/store execution unit. Simple instructions can be sent to any execution queue while load/store instructions are restricted to load/store execution queues and complex instructions are restricted to complex execution queues. Furthermore, arbitration logic is able to select a branch instruction from any of the execution queues, thus allowing branch instructions to be sent to any execution queue. Accordingly, each queue will start with an independent instruction followed by dependent instructions, if any. The instructions from the queue are executed in-order, whereby only the instruction at the bottom of the queue is available to be selected for execution.

Because, for example, load/store instructions can take a substantial amount of time to execute (when, for example, the instruction results in an access to main memory rather than a cache), a load/store queue can become filled with dependent instructions. In conventional processors, once the load/store queue is full, any further dependent instructions designated for storage at the load/store queue are stalled at the dispatch stage. This can undesirably slow down instruction of the processor. Accordingly, as described further herein, in response to determining an execution queue is full and therefore cannot store a dependent instruction, the processor selects another execution queue to store the dependent instruction, and links the full queue to the newly selected queue. The full execution queue is referred to herein for purposes of discussion as the instruction's selected execution queue, and the linked queue is referred to as the link extended queue for the selected execution queue. By storing additional dependent instructions at the link extended queue, the processor temporarily expands the effective storage space of the selected queue, reducing the likelihood of a stall.

As used herein, an independent queue refers to an empty execution queue. Instructions are assigned to execution queues as follows: if the instruction does not depend on another instruction, it is sent to an independent queue and therefore is available to be selected for execution from bottom of the execution queue. However, storing many multi-cycle instructions like load and complex instructions (multiply and divide) in the same execution queue can cause extensive delay for all instructions in the same queue. Accordingly, in an embodiment, a multi-cycle instruction, as first priority, is sent to independent queue even if it depends on another instruction in another execution queue. The multi-cycle instruction is selected for execution as soon as it is ready for execution.

In one embodiment, each execution queue is generally associated with an instruction type such that, if the execution queue is empty, the execution queue is generally designated to store independent instructions of that type. An execution queue associated with a particular instruction type can generally store dependent instructions of another instruction type such as, simple and branch instructions.

When an execution queue is full, and another dependent instruction is available to be stored at the execution queue, the processor first attempts to extend the full queue by selecting another execution queue associated with the same type as the full queue. Thus, for example, the processor can first attempt to extend a full load/store queue by selecting an empty load/store queue as the link extended queue. If none of the other execution queues of the same type are empty, the processor can designate an execution queue associated with a different instruction type as the link extended queue. For example, in the case of a full load/store queue, the processor can select a complex execution queue as the link extended queue when all of the other load/store queues are full.

In one embodiment, the processor reserves a number of execution queues of a particular type such that the reserved queues cannot be used to extend another queue. This ensures that a large set of dependent instructions do not consume too many of the queues of a particular type, thereby reducing processor efficiency. The execution queues that are reserved can be varied based on dynamic conditions, such as the hit rate at a cache of the processor. For example, a high cache hit rate indicates that load/store instructions are likely to be executed relatively quickly, so that the number of reserved load/store queues is set to a lower number (e.g. zero or one). A low cache hit rate indicates that load/store instructions are likely to be executed relatively slowly, so that the number of reserved load/store queues is set to a higher number (e.g. two or more).

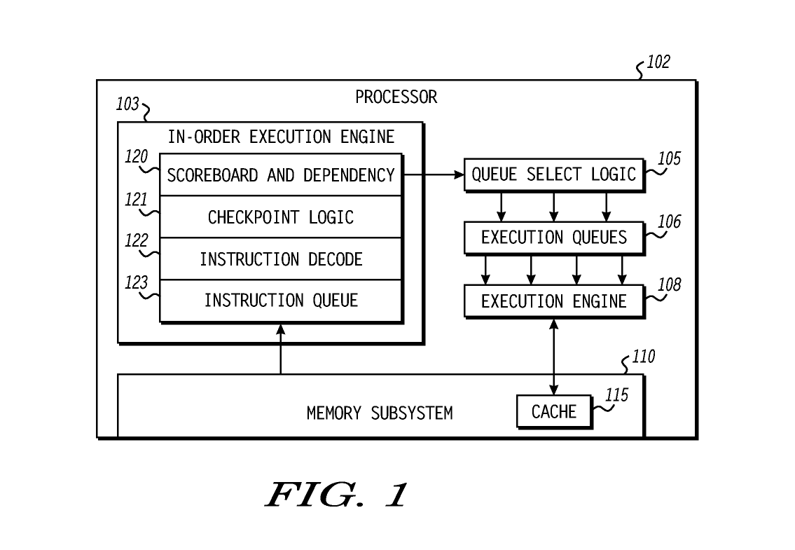

FIG. 1 illustrates a processor 102 in accordance with one embodiment of the present disclosure. In the illustrated example, the processor 102 includes a memory subsystem 110, and an instruction pipeline including an in-order execution engine 103, queue selection logic 105, execution queues 106, and an execution engine 108. The in-order execution engine includes a scoreboard and dependency 120, a checkpoint logic 121, an instruction decode 122, and an instruction queue 123. The memory subsystem is connected to execution engine 108 and to instruction queue 123. The queue select logic 105 is connected to the scoreboard and dependency 120 and is connected to the execution queues 106. The execution queues 106 are also connected to the execution engine 108.

Memory subsystem 110 represents the memory hierarchy of the processor 102. Accordingly, the memory subsystem 110 stores and retrieve instructions and data based on received load/store instructions. The memory subsystem 110 includes a cache 115. In response to a load/store instruction, the memory subsystem attempts to determine if the instruction can be satisfied by accessing the cache 115. If so, the memory subsystem determines there is a cache hit, and satisfies the instruction using the cache 115. If a cache hit is not determined (a cache miss), the memory subsystem 110 satisfies the load/store instruction from another level in the memory hierarchy, such as from system memory (not shown).

The in-order execution unit 103 is generally configured to retrieve and prepare undecoded instructions for execution. Each undecoded instruction represents an opcode, defining the instruction is designated to perform, and also can represent operands indicating the data associated with the instruction. For example, some instructions include a pair of source operands (designated Source 0 and Source 1) indicating the source of data upon which the instruction is performed, and a destination operand, indicating the location where the result of the instruction is to be stored.

The instruction queue 123 is configured to retrieve and store undecoded instructions based on a program flow designated by a program or program thread. The instruction decode 122 is configured to decode each undecoded instruction. In particular, the instruction decode determines the control signaling required for subsequent processing stages to effect the instruction indicated by an instructions opcode. For convenience herein, a decoded instruction is referred to as either a decoded instruction or simply “an instruction.”

The checkpoint logic 121 is configured to determine the architectural registers associated with the operands of each instruction. In an embodiment, the architectural registers are identified based on the instruction set implemented by the processor 102. As described further herein, the processor 102 can include a register file having a set of physical registers, whereby each physical register can be mapped to one of the architectural registers. Further, the particular physical register that is mapped to an architectural register can change over time. The architectural registers thus provide a layer of abstraction for the programmers that develops the programs to be executed at the processor 102. Further, the dynamic mapping of physical registers to architectural registers allows the processor 102 to implement certain features such as branch prediction.

The scoreboard and dependency logic 120 is configured to perform at least two tasks for each instruction: 1) determine whether the instruction is dependent on another instruction; and 2) to record, at a module referred to as a scoreboard, the mapping of the architectural registers to the physical registers. Thus, in response to receiving an instruction, the scoreboard and dependency logic 120 determines whether the instruction is a dependent instruction. As described further herein, the execution engines 108 are generally configured such that they can execute instructions out-of-order. However, the processor 102 ensures that dependent instructions are executed in-order, so that execution of the dependent does not cause unexpected results relative to the flow of the executing program or program thread.

The scoreboard and dependency module 120 provides the instructions to the queue selection logic 105. In addition, for each instruction the scoreboard and dependency module 120 determines the selected queue for the instruction. As described further herein, the selected queue is determined based on the dependency of the instruction, if any, and the instruction type. The scoreboard and dependency module 120 provides each instruction and information indicating its selected queue to queue select logic 105.

The queue select logic 105 determines if the selected queue for an instruction is full. If not, the queue selection logic 105 stores the dependent instruction the selected queue. If the selected queue is full, the queue selection logic 105 attempts to determine if there is a link extended queue for the selected queue. If so, the queue selection logic 105 stores the instruction at the link extended queue. If there is no link extended queue designated for the selected queue, the queue selection logic 105 determines whether there is an independent execution queue available to be designated as a link extended queue. As described further below, this determination can be made based on a number of factors, including which queues are reserved, which execution queues already store instructions, and the like. If an independent execution queue is available, the queue selection logic 105 designates it as the link extended queue for the selected queue. In addition, the queue selection logic 105 extends the selected queue by: 1) storing the instruction at the link extended queue; and 2) storing a link to the link extended queue at the selected queue. If there is no independent execution queue available to store the dependent instruction, the dependent instruction is stalled at the queue selection logic 105.

The execution engine 108 includes a set of execution units to execute instructions stored at the execution queues 106. One or more arbiters of the execution engine select instructions to be executed from the execution queues 106 according to a defined arbitration scheme, such as a round-robin scheme. For each of the execution queues 106, the instructions stored in each execution queue are executed in order, according to a first in, first out scheme. This ensures that dependent instructions are executed in order. Thus, processor 102 can dynamically extend a queue when a set of dependent instructions becomes too large to store in a single queue. Extension of the queues by linking queues together when a queue becomes full provides flexibility. In particular, a single dependency chain of instructions can be stored at multiple link extended queues. In addition, dependency chains of instructions can each be stored an one or more link extended queues. Instructions in the dependency chain are executed in order, traversing the link extended queues. Once all instructions in a queue are executed, the queue is released, so that it can be used to store an independent instruction or as a link extended queue for extension of another dependency chain.

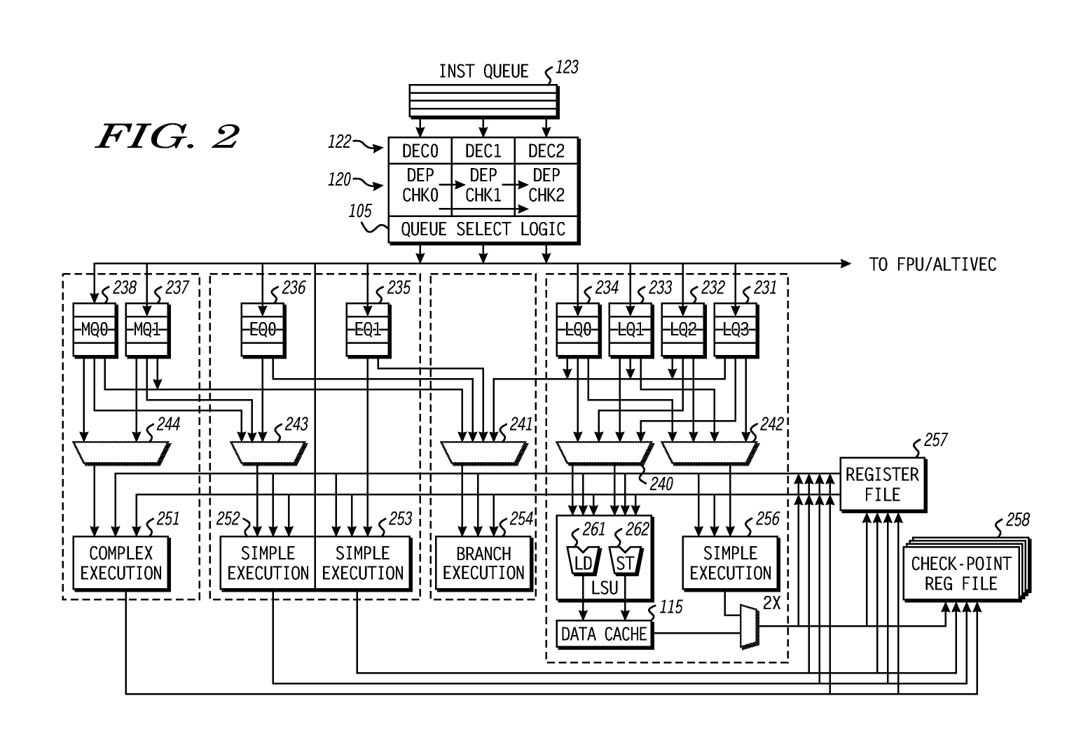

FIG. 2 illustrates a block diagram of portions of the processor 102 in accordance with one embodiment of the present disclosure. In particular, FIG. 2 illustrates the instruction queue 123, the instruction decode 122, the scoreboard and dependency 120, the queue selection logic 105, the execution queues 106, the execution engine 108, and the cache 115. The execution queues 106 include load/store queues 231-234, simple execution queues 235 and 236, and complex execution queues 237 and 238. The execution engine 108 includes arbiters 240-244, complex execution unit 251, simple execution units 252, 253, and 256, branch execution unit 254, load execution unit 261, store execution unit 262, register file 257, and checkpoint register file 258.

The complex execution unit 251, simple execution units 252, 253, and 256, branch execution unit 254, load execution unit 261, and store execution unit 262 each execute instructions of a corresponding type. Thus, complex execution unit 251 executes complex instructions such as multiply and divide instructions. The simple execution units 252, 253, and 256 each execute simple instructions such as shift instructions, integer addition instructions, logical instructions, and the like. In addition, the branch execution unit 254 executes branch instructions, the load execution unit 261 executes load instructions, and the store execution unit 262 executes store instructions.

The register file 257 is accessible to each of the complex execution unit 251, simple execution units 252, 253, and 256, load execution unit 261, and store execution unit 262. The register file 257 includes a set of physical registers that store the operands for executing instructions. In particular, the operands of an instruction can identify a destination register, indicating where data resulting from the instruction is to be stored, and one or more source registers, indicating where data required to perform the instruction is stored. An instruction identifies the operands as architectural registers. The instruction decode 122, checkpoint logic 121, and scoreboard and dependency 120 together determines the physical register at the register file 257 corresponding to each architectural register for the instruction.

The checkpoint register file 258 is a set of registers used to store the state of the registers at register file 257 at designated points, referred to as checkpoints. A checkpoint can be designated, for example, in response to an indication of a speculative branch. The checkpoint register file 258 can be employed to restore the state of the register file 257 to a previous checkpointed state in response to defined conditions, such as an indication of a mispredicted branch.

The arbiters 240, 241, 242, 243, and 244 arbitrate among instructions stored at the bottoms of execution queues to select instructions for execution at each of the execution units 261-262, and 251-256. Arbiter 240 selects a load and a store instruction from load execution queues for load execution unit 261 and store execution unit 262. Arbiter 242 selects a simple instruction from load execution queues for simple execution unit 256. Arbiter 241 selects a branch instruction from load execution queues 231-234, or simple queues 235-236, or complex queues 237-238 from branch execution unit 254. Arbiter 243 selects a simple instruction from simple queue 236 or complex queues 237-238 for simple execution unit 232. Arbiter 244 selects a complex instruction from complex queues 237-238 for complex execution unit 251. Bottom instruction from simple queue 235 is sent directly to simple execution unit 253 without any arbitration. In an embodiment, the arbiters 240-244 ensure that, to the extent possible, each of the execution units 251-256 and 261-262 is continuously executing instructions in parallel with the other execution units. In addition, when there is more than one instruction available to be executed at a particular execution unit. The arbiters 240-244 select which instruction is to be executed. In one embodiment, the arbiters 240-244 select the instruction according to a round-robin arbitration scheme.

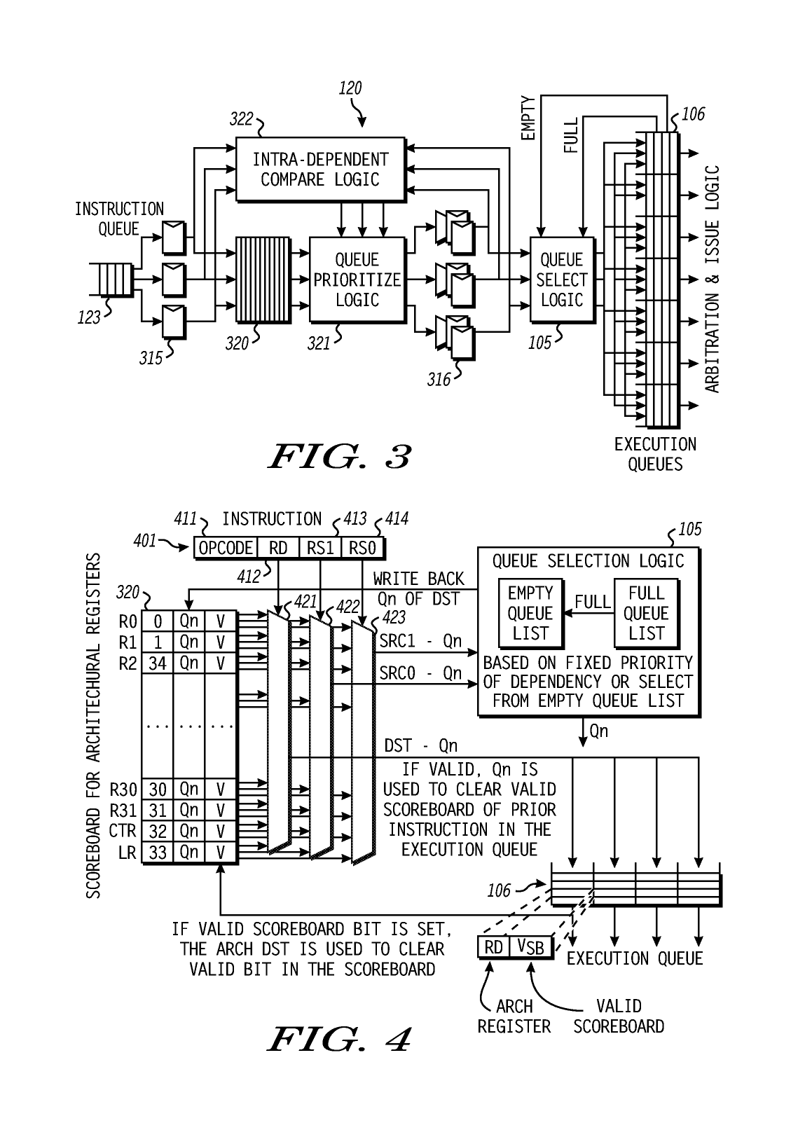

FIG. 3 illustrates a block diagram of portions of the processor 102 in accordance with one embodiment of the present disclosure. Processor 102, as illustrated at FIG. 3, includes the instruction queue 123, the scoreboard and dependency module 120, the queue selection logic 105, and the execution queues 106. In the illustrated embodiment, the scoreboard and dependency module 120 includes a set of input registers 315, a scoreboard 320, queue prioritize logic 321, and a set of output registers 316.

The instruction queue 123 provides sets of three instructions, each instruction in the set stored at a corresponding one of the set of input registers 315. As described further below, each of the input instructions are processed by the scoreboard 320 and the queue prioritize logic 321 in parallel to determine a set of output instructions, stored at the set of output registers 316. The output instructions include information indicating the selected execution queue for each instruction, as well as any other control information needed to execute the instruction.

The intra-dependent compare logic 322 determines whether there are any dependencies between the set of input instructions stored at the set of input registers 315. Because dependency is generally recorded and determined by scoreboard 320, the intra-dependent compare logic 322 allows the input instructions to be processed in parallel without a loss of dependency information.

The scoreboard 320 indicates for each architectural register the corresponding physical register. Because operand dependency is based on the architectural registers that are accessed by the instruction, the scoreboard 320 is employed to determine whether the input operands are dependent on any previous instruction that has not completed execution. In addition, the scoreboard 320 can indicate which of the execution queues 106 stores the previous instruction that is to access the architectural register, thereby indicating the execution queue that stores the instruction upon which the dependent input instruction depends.

Queue prioritize logic 321 determines, based on the dependency information provided by the scoreboard 320, the selected execution queue for each instruction according to a defined hierarchy. The defined hierarchy indicates how a selected queue is to be determined when an instruction is dependent upon multiple previous instructions as described further below. The queue prioritize logic 321 stores an indicator of the selected queue, together with the associated instruction, at one of the output registers 316.

The queue select logic 105 receives the output instructions and selects one of the execution queues 106 to store each instruction based upon its selected queue. In addition, the queue select logic 105 receives control signaling from the execution queues 106 indicating whether each queue is empty, full, or neither. The queue select logic 105 employs the control signaling to determine whether to use the selected queue to store the instruction, whether to extend the selected queue, or whether to stall an instruction at the registers 316.

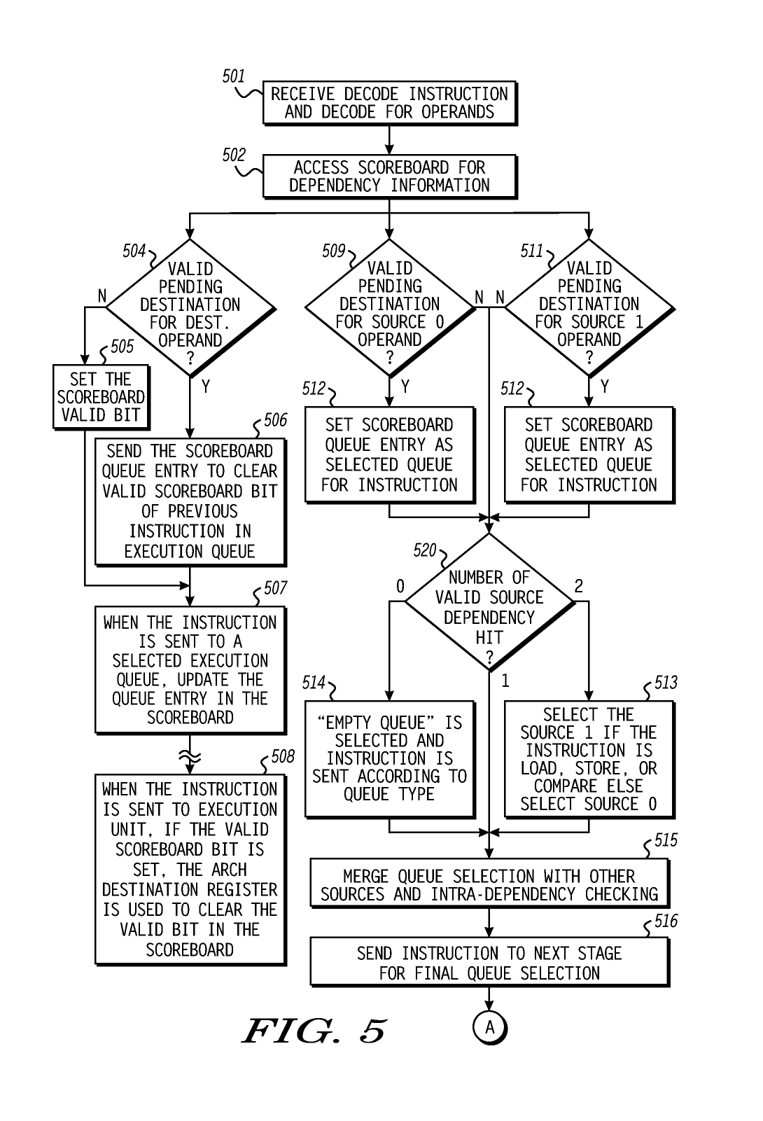

FIG. 4 illustrates an example of the scoreboard 320, queue select logic 105, and execution queues 106 in accordance with one embodiment of the present disclosure. The illustrated embodiment depicts an instruction 401 including an opcode field 411, a destination operand 412, and source operands 413 and 414. The operands 412-414 are expressed as architectural registers. The instruction 401 can be decoded at the instruction decode stage 122 (FIG. 1) into one or more instructions based on the opcode 411.

After instruction 401 is decoded, a rename logic (not shown) selects an available physical register to rename the destination operand of the instruction. In the illustrated embodiment, each row of the scoreboard 320 is associated with a different architectural register. Each row of the scoreboard 320 includes a renamed physical register field, an execution queue field, and a valid bit. The renamed physical register field indicates the physical register most recently assigned to the architectural register corresponding to the row. Thus, in the illustrated embodiment, physical register “34” was most recently assigned to architectural register R2. The queue number field (Qₙ) stores an identifier indicating which of the execution queues 106 stores the corresponding most recently assigned instruction with a destination operand corresponding to the architectural register. For example, in the illustrated embodiment, the third row of the scoreboard 320 stores the value Qn for the queue entry in load execution queue 231-234 with R2 as the destination operand and renamed to physical register 34. As described further below, the queue number field is used to identify which execution queue is to store particular dependent instructions.

The valid bit is used to store an indicator as to whether the corresponding most recently assigned instruction with a destination operand corresponding to the architectural register is still in the execution queue. To illustrate, when the corresponding most recently assigned instruction with a destination operand corresponding to the architectural register is decoded, the destination operand is renamed to an available physical register and written to the renamed physical register field and the valid bit is set for this architectural register. As the instruction is dispatched to an queue entry of execution queues, the execution queue entry is written into the queue number field of the scoreboard. As this entry in the execution queue is selected by the arbiter for execution, the valid bit field of the scoreboard will be reset.

Each operand of every instruction in decode accesses the scoreboard for dependency information and to update the scoreboard fields. A decoded instruction has 3 operands, 412, 413, and 414. Each operand corresponding to 3 read ports, 421, 422, and 423 of the scoreboard. Read ports 421, 422 and 423, provide instruction dependency information to the queue selection logic 105, so that the instruction can be sent to an independent execution queue, a dependent execution queue or an extended execution queue as described in further detail below with respect to FIG. 6. Read port 421 for destination operand 412 provides an indication of the current corresponding most recently assigned instruction with the destination operand corresponding to the architectural register. Since the decoded instruction will be the most recently assigned instruction with the destination operand corresponding to the architectural register, the “write-back” status of the current corresponding most recently assigned instruction with the destination operand corresponding to the architectural register must be reset as described below.

The execution queues 106 store instructions and associated control information. In the illustrated embodiment, the control information for each instruction includes the destination architectural register associated with the instruction and a valid scoreboard bit “V_{SB}.” The V_{SB} bit indicates whether the corresponding instruction is the instruction whose execution will trigger the clearing of the valid bit at scoreboard 320 corresponding to the destination architectural register. The “V_{SB}” is set only for the most recently assigned instruction with the destination operand corresponding to the architectural register. When another instruction is decoded with the same destination operand (same architectural register), then “V_{SB}” for the previous instruction must be cleared. The Qn of the current corresponding most recently assigned instruction with the destination operand corresponding to the architectural register is used to go directly to the queue entry in execution queues to clear the “V_{SB}” bit.

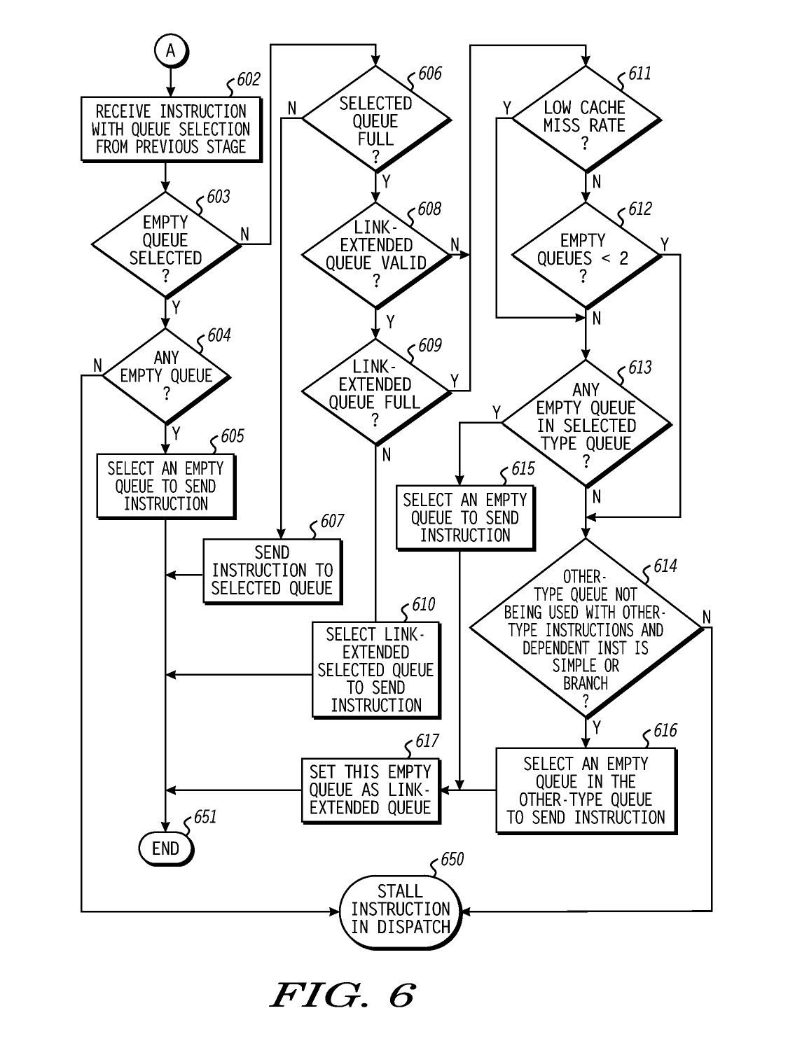

The instruction of the processor portions illustrated at FIG. 4 can be better understood with reference to FIG. 5 and FIG. 6, which together illustrate a method of assigning one of the execution queues 106 to an instruction in accordance with one embodiment of the present disclosure. At block 501, the scoreboard 320 receives an instruction 401 including decoded instruction information (the opcode 411) and decoded operand information (the operand fields 412-414). At block 502 the operand fields 412-414 read the scoreboard 320 to determine the dependency information. At block 504, the scoreboard 320 determines if the valid bit for the destination operand's architectural register is set. If not (i.e. currently there is no pending instruction that writes to this architectural register), the method flow moves to block 505 and sets the scoreboard valid bit for this architectural register, indicating that the decoded instruction is the corresponding most recently assigned instruction with destination operand corresponding to this architectural register. The method flow proceeds to block 507, described below. If, at block 504 the scoreboard 320 determines the valid bit for the destination operand's architectural register is set, the scoreboard 320 sends control information to the execution queue indicated by the Qₙ field of the architectural register, resetting the V_{SB} bit of the current pending instruction that writes to the architectural register. This ensures that the scoreboard valid bit associated with the architectural register is cleared only by the most recently assigned instruction with destination operand corresponding to this architectural register. The “V_{sB}” bit is set for this decoded instruction. For each architectural register, there should be only one “V_{sB}” bit is set. In particular, the only V_{SB} set for each architectural register is the V_{SB} bit for the most recently instruction with destination operand corresponding to this architectural register in all execution queue entries. The method proceeds to block 507.

At block 507, when the instruction is sent to a selected execution queue, the queue selection logic 105 updates the QN entry for the destination architectural register to the identifier for the selected execution queue. The scoreboard 320 thus indicates, for each destination architectural register, which of the execution queues 106 stores the most recent instruction that writes the architectural register as its destination.

At block 508, when an instruction is sent from one of the execution queues 106 to an execution unit for execution, a control module at the execution queues 106 determines if the V_{SB} bit for the instruction is set. If so, the control module sends information to the scoreboard 320 to clear the valid bit for that destination architectural register, thereby indicating that the data for this architectural register is now in the physical register file and not pending in the execution queue.

At block 509 and 511, concurrently with determining if the valid bit for the destination operand's architectural register is set at block 504, the scoreboard 320 determines if the valid bit for the source operands' (designated “Source 0” and “Source 1”) architectural registers are set. If so, in blocks 510 and 512, the queue prioritize logic 321 sets the instruction to be stored at the same execution queue indicated by scoreboard queue entry Qₙ for Source 0's and Source 1's architectural register, respectively. If the scoreboard valid bit is not set, then there is no pending instruction in the queue that will write to the architectural register reference by the source register. In this case, the architectural register data is stored in the “renamed” physical register as indicated by the “renamed” physical register field of the scoreboard. The “renamed” physical register replaces the source operand of the decoded instruction and as the instruction is selected for execution by the arbiter, the data from the “renamed” physical register is the source data for execution. After the dependencies for the source operands are established, the method flow proceeds to block 520 to evaluate the number of valid source dependencies. The method flow proceeds to block 513 if both source operands detect dependency with prior instructions in execution queues, described below. The method flow proceeds to block 514 if no source operand dependency is detected.

At block 514, since there is no dependency, the queue prioritize logic 321 sets the instruction to be stored at an empty one of the execution queues 106 based on the instruction type.

At block 513, the queue prioritize logic 321 sets the instruction to be stored in the same Qn as Source 1's architectural register when the instruction is a load instruction, a store instruction, or a compare instruction, and otherwise sets the instruction to be stored in the same Qn as Source 0's architectural register. The method flow moves to block 515.

At block 515 the queue prioritize logic merges the queue selection based on the source operands for the instruction with other sources being concurrently processed at other dependency detecting logic. In one embodiment, the instruction includes carry bit and conditional registers as other sources. In addition, the multi-cycle instructions such as load, multiply, and divide instructions can be set as independent instruction regardless of source operand dependency. The method flow moves to block 516, where the instruction is sent to the queue select logic 105 for final queue selection, illustrated at FIG. 6.

At block 602 of FIG. 6, the queue select logic 105 receives the instruction from the queue prioritize logic 321. At block 603, the queue select logic determines whether the instruction is independent and has been set to be stored at an empty execution queue. If so, the method flow moves to block 604 and the queue selection logic 105 determines whether there is any empty queue associated with the instruction type of the received instruction. If so, the method proceeds to block 605 and the queue selection logic selects one of the empty queues associated with the type of instruction and provides the instruction to the selected execution queue for storage. If there is no empty execution queue of the appropriate type, the method flow proceeds to block 650 and the instruction is stalled at the queue selection logic 105.

Returning to block 603, if the instruction is a dependent instruction and has been set for storage at a non-empty execution queue, the method flow moves to block 606 and the queue select logic 105 determines if the selected queue is full. If not, the method flow proceeds to block 607, where the queue select logic sends the instruction to the selected execution queue for storage. The method flow proceeds to block 655, where the method ends. If, at block 606, the queue select logic 105 determines that the selected queue is full, the method flow moves to block 608 determines whether another queue is already being used as an extended queue for the selected queue instruction. If so, the method flow moves to block 609 and the queue select logic determines whether the extended queue is full. If not, the method flow moves to block 610 and the queue select logic 105 sends the instruction to the extended queue for storage. The method flow proceeds to block 655, where the method ends.

If, at block 608, it is determined that there is no extended queue available or it is determined at block 609 that the extended queue is full, the method flow moves to block 611 and the queue select logic 105 determines a current cache hit rate for the cache 115. In one embodiment, the cache hit rate is monitored by a performance monitor module (not shown), which periodically updates a register accessible by the queue select logic 105 to indicate the current cache hit rate. If the queue select logic 105 determines that the cache miss rate is high (e.g. because the cache hit rate is below a threshold), the method flow moves to block 612 and the queue select logic determines if the number of empty queues of the type associated with the received instruction is less than 2. It will be appreciated that values other than 2 can be used without departing from the scope of this disclosure.

If the number of empty queues is greater than or equal to 2, or if the queue select logic 105 determines that the cache miss rate is low, the method flow proceeds to block 613, where the queue select logic 105 determines if there are any empty execution queues associated with the instruction type. If not, or if the number of empty queues is less than 2, this indicates that there are no queues of the instruction type available to store the instruction. Accordingly, the method flow proceeds to block 614, and the queue select logic 105 determines if the execution queues associated are with another instruction type are not being used to store instructions of the other type and if the dependent instruction is a simple or branch type instruction. As an example, if a dependent instruction is set to go to a load queue and all load queues are full, this dependent instruction can be sent to a complex queue. If the complex queue is being used by complex instructions as indicated by block 614, then the dependent instruction should not be extended to the complex queue. Accordingly, the method flow proceeds to block 650 where the instruction is stalled at queue select logic 105.

If at block 614, the queue select logic 105 determines that an execution queue associated with a different type of instruction is not being used to store instructions of the other type and the dependent instruction is a simple or branch type instruction, the method flow moves to block 616 and the queue select logic selects an empty queue of the other type. As with the above example, if the complex queues do not store any complex instruction, then an extended queue can be created for a dependent instruction from the “full” load queue. But if the dependent instruction is a store or load instruction, then the instruction is stalled in block 650. The method flow moves to block 617 and the queue select logic 105 sets the selected empty queue as the link extended queue for the originally selected execution queue. In addition, the queue select logic 105 sends the instruction to the link extended queue and stores a link to the link extended queue at the originally selected queue. The selected queue is used to update the Qn field of the scoreboard based on destination operand's architectural register. The method flow moves to block 655, where the method ends.

Returning to block 613, if the queue select logic 105 determines that there is an empty queue of the instruction's type, the queue select logic 105 selects an empty queue of the instruction's type at block 615. The method flow moves to block 617 and the queue select logic sets the selected empty queue as the link extended queue for the originally selected execution queue. In addition, the queue select logic 105 sends the instruction to the link extended queue and stores a link to the link extended queue at the originally selected queue. The method flow moves to block 655, where the method ends.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

As used herein, the term “bus” is used to refer to a plurality of signals or conductors that may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

As used herein, the term “machine-executable code” can refer to program instructions that can be provided to a processing device and can be executed by an execution unit. The machine-executable code can be provided from a system memory, and can include a system BIOS, firmware, or other programs. In addition, machine-executable code can refer to microcode instructions that can be used by a processing device to execute program instructions, and can be provided by a microcode memory of the processing device.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method, comprising:
decoding at a processor a first instruction to determine a first decoded instruction;
in response to determining the first decoded instruction is dependent on a second instruction, assigning the first decoded instruction to a first queue of a plurality of execution queues;
in response to determining the first queue is full, storing the first decoded instruction information at an entry of a second queue of the plurality of execution queues in response to determining the second queue is not full, the second queue able to store independent instructions when it does not store instructions dependent on instructions stored.

2. The method of claim 1, further comprising arbitrating between entries of the first queue and entries of the second queue for provision to an execution unit of the processor.

3. The method of claim 1, further comprising:
in response to determining the second queue is full, storing the first instruction information at an entry of a third queue.

4. The method of claim 3, wherein storing the first instruction information at the entry of the third queue comprises storing the first instruction information at the entry of the third queue in response to determining the third queue does not store a third decoded instruction of a type associated with the third queue, and further comprising:
stalling the first decoded instruction in response to determining the third queue stores the third decoded instruction of the type associated with the third queue.

5. The method of claim 1, further comprising:
determining if the first decoded instruction is dependent on the second instruction based on a scoreboard that keeps track of pending instructions in the first and second queues.

6. The method of claim 5, further comprising:
in response to determining the first decoded instruction is dependent on multiple instructions stored at multiple queues, selecting a queue to store the first decoded instruction based on a specified set of priorities.

7. The method of claim 1, further comprising selecting the second queue based on a cache miss rate at a cache of the processor.

8. A method, comprising:
decoding at a processor a first instruction to determine a first decoded instruction;
selecting a queue to store the first decoded instruction based on a hit rate at a cache of the processor.

9. The method of claim 8, wherein the first decoded instruction is dependent on a second instruction of a first type, and wherein selecting the queue comprises storing the first decoded instruction at a queue designated to store independent instructions of a first type of instruction in response to determining the hit rate is above threshold.

10. The method of claim 9, wherein selecting the queue comprises storing the first decoded instruction at a queue designated to store independent instructions of a second type different than the first type in response to determining the hit rate is below the threshold.

11. The method of claim 9, wherein the first type is a load/store type of instruction, and the second type is a complex type of instruction.

12. The method of claim 9, further comprising:
determining if the first decoded instruction is dependent on the second instruction based on a scoreboard that keeps track of pending instructions in the first and second queues.

13. The method of claim 8, wherein selecting the queue comprises linking a first queue to a second queue in response to determining the first queue is full, and storing the first decoded instruction at the second queue.

14. A processor, comprising:
a decode stage to determine a first decoded instruction;
a plurality of execution queues to store decoded instructions awaiting execution, the plurality of execution queues comprising a first queue and a second queue; and
a queue selection module to assign the first decoded instruction to the first queue, and to store the first decoded instruction information at an entry of the second queue in response to determining that the first decoded instruction is dependent on a second instruction and that the first queue is full.

15. The processor of claim 14, further comprising:
a scoreboard based to keep track of pending instructions in the plurality of queues, the scoreboard comprising a plurality of entries, each of the plurality of entries associated with a corresponding architectural register and comprising:
a renamed physical register field;
a queue number indicating the location of the most recently instruction with destination operand's architectural register
a valid bit to indicate a pending write to the corresponding architectural register;
the queue selection module to assign the first decoded instruction to the first queue based on one of the pluralities of entries of the scoreboard.

16. The processor of claim 15, wherein the plurality of execution queues each includes a plurality of queue entries, each of the plurality of queue entries comprising:
a valid scoreboard bit to indicate if an instruction stored at the entry is the most recent instruction with the architectural register of the instruction's destination operand.

17. The processor of claim 15, wherein the queue selection module is to, in response to determining that the first decoded instruction is dependent on multiple prior instructions, to select the first queue based on a defined priority.

18. The processor of claim 15, further comprising an arbitrator coupled to the plurality of execution queues to arbitrate between entries of the first queue and entries of the second queue for provision to an execution unit of the processor.

19. The processor of claim 18, wherein the queue selection module is to store the first instruction information at an entry of a third queue of the plurality of execution queues in response to determining the second queue is full.

20. The processor of claim 15, wherein the queue selection module is to select the second queue based on a cache miss rate at a cache of the processor.
